(19) United States
(12) Patent Application Publication
(10) Pub. No.: US 2008/0239980 A1
(43) Pub. Date: Oct. 2, 2008

(54) LINEAR TIME INTERFERENCE MAP FOR 802.11 NETWORKS

(75) Inventor: Dragos Niculescu, Highland Park, NJ (US)

Correspondence Address: NEC LABORATORIES AMERICA, INC., 4 INDEPENDENCE WAY, Suite 200, PRINCETON, NJ, 08540, US

(73) Assignee: NEC Laboratories America, Inc., Princeton, NJ (US)

(21) Appl. No.: 12/030,542

(22) Filed: Feb. 13, 2008

Related U.S. Application Data
(60) Provisional application No. 60/909,468, filed on Apr. 1, 2007.

(51) Int. Cl. G06F 11/30

(52) U.S. Cl. 370/252

(57) ABSTRACT

The present invention advantageously provides a method for estimating an interference map for nodes in a network by continuously broadcasting packets from a jammer node at maximum capacity, simultaneously recording a delivery ratio from the jammer node to every other network node, concurrently, for all nodes except the jammer node, randomly broadcasting data, recording a sender interference of the node to another node having the sender interference from the jammer node, recording a receiver interference of the second node to the first node having the receiver interference from the jammer node, and performing each of the previous steps for all network nodes. The sender interference can be determined by broadcasting the data at a fixed rate when the jammer node's sender interference disabled, or by unicasting data from a node more than once to a nonexistent address, and measuring a time difference between receiving the broadcast data.

### CROSS REFERENCE TO RELATED APPLICATION

The present invention claims the benefit of U.S. provisional patent application 60/909,468 filed Apr. 1, 2007, the entire contents and disclosure of which is incorporated herein by reference.

### FIELD OF THE INVENTION

The present invention relates generally to wireless local area networks. In particular, the invention relates optimizing the calculation of an interference map for a wireless local area network.

### BACKGROUND OF THE INVENTION

As the density of WiFi networks increases, interference becomes a deciding factor for the achievable performance. For WLAN 802.11, the density increases because of popularity, low cost and compatibility. For 802.11 meshes, the required density is inherently higher as mesh nodes need to be within range of each other, while WLAN access points need not. Even though multiple card nodes are available and are required in multihop networks in order to sustain throughput across several hops, the number of channels may be limited. For example, for some of the current 802.11 networks, the number of channels is limited to three, so interference cannot be completely eliminated.

The availability of 802.11a, with its shorter range, higher bit rates, and more available orthogonal channels, provides one way of scaling up the wireless service by increasing the bandwidth per area ratio. But this is achieved by increasing the density of access points and the number of wireless cards per access point. In such a dense wireless network, be it multiple hop (ad-hoc, mesh) or single hop, several base stations and clients operating on the same channel are bound to interfere with each other. Further, indoors the nature of interference is generally unpredictable for carriers (2.4 GHz and 5 GHz) due to variability in building construction, people movement, and other uncontrolled sources, such as microwave ovens.

In addition, channel usage is unregulated by most institutions, so that it is generally hard to predict what quality of service can be achieved even in a one hop setup. For multiple hops, the problem becomes harder because, when carried on the same channel, backhaul traffic interferes with itself. The nature of the traffic also makes the amount of interference hard to predict. For example, TCP traffic depends on the congestion, which means that the interference it produces depends on conditions on other orthogonal channels. In a mesh, this tends to link together the problems of channel allocation, routing and call admission.

While there is research that incorporates interference information for the mentioned problems, interest in the actual measurement and modeling of interference is quite recent. In “Estimation of Link Interference in Static Multi-hop Wireless Networks,” Internet Measurement Conference, 2005, Padhye et al. proposed a pairwise interference measurement method, which has several stages and is sketched in Algorithm 1 shown in Table 1 and discussed in detail below. The broadcast based interference estimation is shown by Padhye et al. to be an adequate estimation for interference produced between unicast flows. In “Properties of Interference in a Dense 802.11 Wireless Network,” Technical Report 2006-L072, NEC Laboratories America, Inc., June 2006, Niculescu et al. used the same measurement method to produce a data structure called an interference map which is a collection of data structures that completely characterizes interference of devices on a channel for a population of 802.11 devices. The characterization includes all carrier sense and interference relationships in the network.

TABLE 1
Algorithm 1
Basic procedure for Pairwise Interference Measurement

```
1) one node A in the network sends broadcast packets at maximum
capacity and every other node B records the delivery ratio A -> B.
2) all nodes take turns in running step 1.
3) one pair (A, B) sends broadcast packets at maximum capacity.
    a) every other node C records the delivery ratios:
        d^{C}_{A,B}, being the delivery ratio A -> C with B acting
        as a jammer, and
        d^{C}_{B,A} being the delivery ratio B -> C with A acting as a jammer.
    b) at the same time B and A record the packet rate they can
    each put on to the air.
4) all unordered pairs in the network take turns at executing step 3.
```

Padhye et al. also found that carrier sense (CS) is the major cause for interference. Another study of carrier sense, “Understanding the Real-World Performance of Carrier Sense,” K. Jamieson, B. Hull, A. Miu, and H. Balakrishnan, ACM SIGCOMM Workshops, 2005, demonstrates that cs is not always a good predictor of transmission success, and also suffers of the exposed terminal problem wherein close by senders cannot send simultaneously even if their destinations can actually receive packets. In addition, cs is shown to be overly conservative with respect to the capture effect.

The question of interference is acknowledged to be central for the problems of channel assignment, bandwidth allocation and routing in “Centralized Channel Assignment and Routing Algorithms for Multi-Channel Wireless Mesh Networks,” Ashish Raniwala, Kartik Gopalan, and Tzi-cker Chiueh, ACM Mobile Computing and Communications Review, volume 8, number 2, April 2004. Other researchers have identified interference as being a cause for unfairness, and the most studied problem is that of capacity being affected by interference. More recent works, such as “Measurement-Based Models of Delivery and Interference in Static Wireless Networks,” Charles Reis, Ratul Mahajan, Maya Rodrig, David Wetherall, and John Zahorjan, ACM SIGCOMM, Pisa, Italy, September 2006, try to reduce the complexity of measuring the interference by only considering pairwise communication, but this ignores the remote interferers, that is those outside carrier sense range, which are the main source of uncontrolled loss.

Often, complex interference scenarios are considered an input for the optimization process without addressing the problem of obtaining them. There is a circular dependency between these problems and interference, that is, a circular dependence with routing, call admission and channel allocation, in that any solution to one or more of these three problems reconfigures interference patterns. The interference map helps in predicting traffic quality given some input traffic matrix. One of the critical aspects of the interference problem is to identify hidden terminals, as they have a major negative impact on packet loss. Some known solutions have high complexity by exploring the behavior of each pair of nodes in the network one pair at a time. Other solutions ignore the hidden terminals altogether, which results in lower throughput.

### BRIEF SUMMARY OF THE INVENTION

The present invention advantageously provides a method that reduces the complexity of measurement required to calculate the interference map. The basic idea is to use randomization to overlap measurements that were previously performed in a serial fashion. The methods proposed benefit by some support from hardware/firmware, but can also be implemented in a manner assuming no special firmware support.

Accordingly, the present invention advantageously provides a method for estimating an interference map for a plurality of nodes in a network, comprising the steps of continuously broadcasting packets from a jammer node of the plurality of nodes at maximum capacity, simultaneously recording a delivery ratio from the jammer node to each node of the plurality of nodes, each node distinct from the jammer node, randomly broadcasting data from a first node of the plurality of nodes, the first node distinct from the jammer node, recording a sender interference of the first node to a second node of the plurality of nodes having the sender interference from the jammer node, the second node distinct from the first node and the jammer node, recording a receiver interference of the second node to the first node having the receiver interference from the jammer node, the steps of recording the sender interference and recording the receiver interference are performed concurrently for all nodes; and performing each of the previous steps for each node of the plurality of nodes to estimate the interference map comprising the delivery ratio, the sender interference, and the receiver interference for each node.

In one embodiment, the sender interference can be determined by broadcasting the data at a fixed rate when the continuous broadcasting of packets is performed with the jammer node's sender interference disabled. The fixed rate can be an average rate. In another embodiment, the sending interference can be determined by unicasting data at least a first time and a second time to a nonexistent address from a first node of said plurality of nodes, said first node distinct from said jammer node, and measuring a time difference between a receipt of the broadcast data broadcast the first time and the second time at the first node, the time difference being used to calculate the sender interference.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 illustrates interference areas of interest;

FIG. 2 illustrates detection of CS relation between nodes; and

FIG. 3 illustrates the flow of an exemplary embodiment.

### DETAILED DESCRIPTION OF THE INVENTION

A method to calculate an interference map is presented. When considering the interference that can affect a communication between two nodes i and k, several areas of interest are distinguishable. All these areas are seldom circles especially for indoors 802.11, but they are discussed as such, bearing in mind the potential differences.

### Interference Map

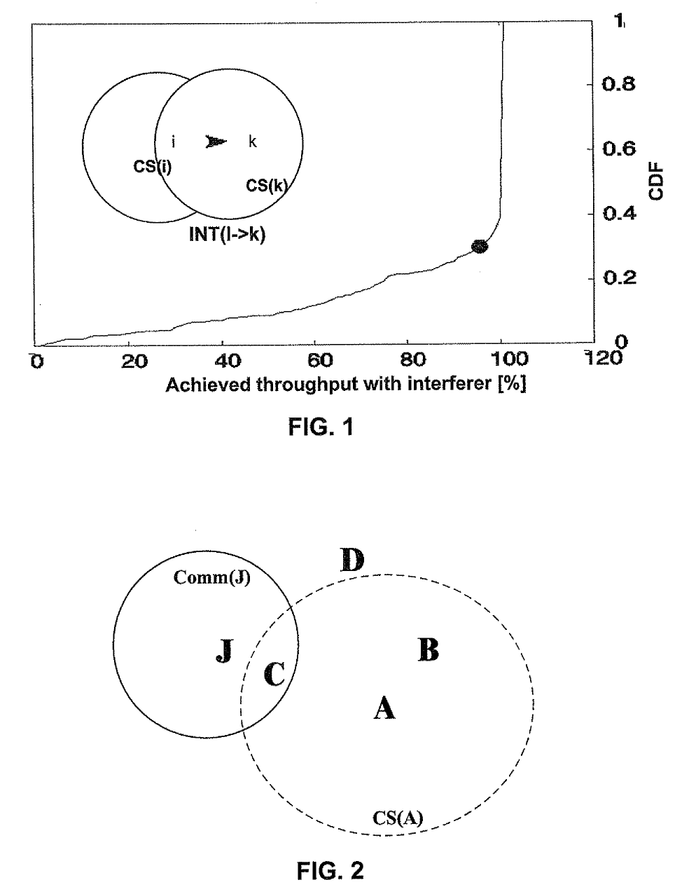

FIG. 1 illustrates interference areas of interest, and graphs the cumulative distribution function (CDF) of “average achievable throughput” of a link in the presence of a single interferer. In FIG. 1, measurements are performed in a twenty (20) node 802.11a mesh. The point or dot on the graph line indicates that ninety-five percent of the links can be degraded to one third of capacity or below. Note that carrier sense (CS) of node i (CS(i)) can be considered as a set and described using set notation.

FIG. 1 indicates CS ranges for the sender node i and for the receiver node k, and the interference range specific for distance or link between source or sender i and destination or receiver k (i→k). CS(k) is the area in which a potential sender will sense the presence of k and will defer transmission when needed. The size of the CS and interference circles depends on hardware, settings (power, sensitivity), and local conditions. Generally, if a jammer j is placed in area CS(i) excluding area CS(k) (CS(i)\CS(k)), the jammer j senses the presence of i and won't destroy its packets, but rather shares the medium or channel.

Interference for a link i→k (INT(i→k)) is defined as the cumulative effect other nodes in the network have on throughput achievable in that link. Area INT(i→k)\CS(i), which includes CS(k)\CS(i) is a hidden terminal region in which a jammer j may destroy packets received at k, because the jammer j does not sense the sender i so that both send packets at the same time. The actual collision at k happens if the jammer has enough power relative to the power of the packet received by k. For this reason, the interference range cannot be described by a circle for the pair (i, k) but must be considered as a condition for the triplet (i, j, k).

In order to predict network conditions in dense deployments, a global understanding of the relations described above is necessary. When i sends data to k, the performance of this communication is influenced by the following three factors. The first is the original quality of the link i→k (in absence of interferers). The second is jammers which are in CS with the sender i, and the third is jammers which are interfering with the reception at k. In order to predict performance, all three aspects must be considered because in both WLAN and mesh, any base station and access point operating on the same channel is at the same time both a legitimate sender and a potential interferer. The amount of data successfully transmitted between i and k also determines the amount of interference node i creates for other receivers in the network; hence the global aspect of the problem.

As discussed above, some nodes may reduce i's sending capacity by being in its CS range, or may destroy packets after they arrive at k. Therefore, differentiating between sending and receiving interference is advantageous because they are qualitatively different. Sending interference caused by CS is nondestructive, yet receiving interference destroys packets requiring their retransmission. Sending interference grabs the resource, i.e. the carrier, to support some useful transfers. Receiving interference is much more wasteful in that it corrupts packets at the destination, after the resource has already been used.

Having a large population of wireless devices in an area operated on a small number of channels brings the question of how devices on the same channel interact. Any two devices are in one of the four situations described above, but the amount of interference they create depends on the amount of traffic they carry, and is therefore linked to problems of routing, load, call admission and channel allocation. The interference map, that is, a data structure that characterizes the interaction of devices on a channel, can answer questions like the following. Given a channel allocation and routing, is a particular traffic matrix supported? Can an additional call be accommodated? When a link goes down, can the current service be maintained? What is a channel coloring that favors particular patterns of traffic (tree, mesh)?

The information in the interference map has three disjoint, but dependent parts: the delivery ratio matrix, the CS graph, and the hidden terminal relationships. Sending interference, or the CS graph, described in more detail below, governs what can be sent into the air, which is the first step in getting the data across in the wireless network. Receiving interference, or the hidden terminal aspect, is the receiver interference information and describes what can be received at a destination under interference from other nodes. Receiving interference is described in more detail below.

### Carrier Sense Mapping

When two nodes sense each other, they share the medium completely, and the sum of their maximum output rates (on to the air) is 1. When they are out of CS range of each other, each of them can send at full throttle, yielding a total output rate of 2. Any value between 1 and 2 is possible, because CS is not a symmetric or discrete phenomenon, that is, one node may sense the carrier from a source only a fraction of the time, or the CS may behave asymmetrically.

The CS graph can be defined or depicted as an n×n mostly symmetric matrix describing the capacity that two nodes can put on air when sending at the same time. csᵢₖ designates what fraction of the nominal capacity node i can put on air when k is active at maximum capacity as well. csᵢₖ+csₖᵢ represents the total capacity placed on the air and ranges from 1 to 2. If the traffic a node places on the air is less that 0.75, the node is considered to defer to another node. This relationship determines the CS graph or matrix, and it is created or built by sending broadcast traffic at full throttle from all possible pairs of nodes, one pair at a time. The packet rate reported by each node is used as a measure for the traffic that can be put on to the medium. If the sum of total capacity is 2, then there is no link between the two nodes in the CS graph. If the sum is 1, then there are two bidirectional links, each node pointing to the other. A sum around 1.5 usually indicates a unidirectional CS link such that one node has an output of 1, and the second of 0.5 because the first node does not hear the second. The direction of the link in the CS graph indicates the direction of sensing.

Using this graph, any output rate vector can be validated as follows. For each node, the sum of its rate, and of rates of its CS neighbors should be less than 1. Accordingly, a call admission decision should first poll the affected nodes and make sure they can actually output the desired traffic under the existing CS conditions. To compute how much of that traffic can actually be received is the role of receiving interference mapping, which is described below.

### Receiving Interference Mapping

The purpose of the receiving interference map is to provide an estimate of the effect a remote source j has over traffic sent from i to k. When i and j are in CS range, they share the medium, and j does not destroy i's packets at k. However, when j does not sense i's transmission, packets received at k may be garbled; as discussed above, this is known the hidden terminal problem. For example, when j is silent and i sends, throughput i→k is d^{k}_{i,j}=5 Mbps. When j and i both send, throughput i→k becomes d^{k}_{i,j}=3 Mbps. The conclusion is that traffic leaving j produces a degradation of forty percent for traffic i→k. The receiving interference map collects the measurements d^{k}ᵢ and d^{k}_{i,j} for all triplets (i, j, k) in the network. The complexity of collecting the entire data set is O(n²) where n is the number of nodes in the network.

### Measurement Mapping Procedure

As discussed above, the pairwise interference measurement process has several stages, as illustrated in Algorithm 1 shown in Table 1. There are in fact two disjoint procedures, one for deliver ratio collection and the other for sender and receiver interference. Steps 1.1 and 1.2 of Algorithm 1 collect delivery ratios for all pairs of nodes in the network. Although there are n² such pairs, since broadcast is used, n steps can be performed concurrently; therefore, the complexity of this data collection is linear. Note that if the proper conditions are met, i.e. no interference, the deliver ratios can be also obtained from live traffic.

For sender and receiver interference, steps 1.3 and 1.4 of Algorithm 1 produce two measurements: sender interference, e.g. CS, and receiver interference. A and B can each send out packets at up to maximum rate (normalized to 1), and from the amount of contention these nodes experience, they produce cs_{AB} and cs_{BA} based on data collected in step 1.3b. When the jammer is in CS with the sender, sender interference is properly captured by the CS graph. However, when the jammer is out of CS range of the sender, the receiver interference that is measured in step 1.3a is retained. When CS is independent, it is possible to combine the effect of individual jammers as their effect on the destination is independent.

The complexity of the procedure of Algorithm 1 is O(n) for the delivery ratios, and O(n²) for both the CS and receiver interference graphs. This is prohibitive for dense networks and for large networks, in part because all steps require the absence of any traffic in the measured network. For example, in our twenty node network with ten second measurements, 3.5 hours were necessary to collect all the data structures.

### Randomized Measurements

The complexity of the measurement could be reduced if the steps in Algorithm 1 that have O(n²) complexity could be performed at the same time. One method to simulate this concurrency is to have short measurements randomly distributed in time so that the probability of them overlapping is negligible.

### Randomized CS Measurements

FIG. 2 illustrates a permanent jammer J with its communication range and node A with its CS range. Equal CS ranges for nodes A, B, C, and D are assumed for simplified representation. CS(J) (not shown) can be larger or smaller than CS(A), depending on the power J is using. Depending on hardware primitives available, either of two similar algorithms can be used to determine whether A [symbol] CS(J).

TABLE 2
Algorithm 2
Randomized CS Measurement with CS disabled

1) Node J broadcasts at full capacity with CS disabled.
2) Every node A (excluding J) in the network broadcasts at a rate f.
a) every node A (excluding J) records whether A ∈ CS(J).
3) All nodes in the network take turns at running step 2.

Algorithm 2 shown in Table 2 aims to concurrently perform the simultaneous recording of the packet rate which nodes A and B can each put on to the air, that is, to run all of the steps in step 1.3b of Algorithm 1. In Algorithm 2, a permanent jammer (node J) sends at full capacity with CS disabled, and several senders concurrently try to estimate whether they are deferring to the jammer or not. Note that A [symbol] CS(J), that is a 0-1 discretization of cs_{AJ}, is measured.

This embodiment requires access to the firmware or card API to increase the CS power threshold of J, as shown in Jamieson et al. Since J uses the medium irrespective of other senders, nodes in CS(J) will not be able to send out even one packet, while nodes far from J get regular access to the medium. Since a binary decision determines whether A is in CS(J), the false positives and the false negatives possibilities of this process are a concern. Fortunately, false negatives are not possible because J is broadcasting at all times. False positives can happen when A's access fails after the maximum number of allowed retries. However, this likelihood is very small for low node densities and low values of f, as it will only happen when each contention is lost by A to some other node in its CS range. While this solution is simple, it depends on access to firmware to disable CS. For example, Jamieson et al. is geared towards Atheros 5210 chipsets and reported not to work on the newer Atheros 5212 chipsets. Another option is to use the 802.11e extension that is supported by drivers such as madwifi, which allow reduction of the contention window to 1 (both cwmin and cwmax) for voice data, which would guarantee J to always win the contention when A base stations use a cwmin>1.

Algorithm 3, shown in Table 3, provides an alternative approach to carrier sender interference.

TABLE 3
Algorithm 3
Randomized CS Measurement with Unicast Pairs

1) Node J broadcasts at full capacity.
2) Every node A (excluding J) in the network unicasts pairs at a rate f to
some nonexistent MAC address
a) every node A (excluding J) records whether A ∈ CS(J).
3) All nodes in the network take turns at running step 1.

This second embodiment, Algorithm 3, uses a jammer (node J) that uses normal CS, and may therefore defer to nodes when in their range. This implementation is not dependent on support from firmware. In this embodiment, node A sends data or packets, with retry set to two (2), to a nonexistent Medium ACcess layer (MAC) address. On the first try, the packets are not ACK, and a second retry is used. The difference in time between the receipt of these packets helps A decide whether it defers to J. If the difference is short, for example, one packet long, it means the retries are sent back to back. However, if the difference is longer, it means that J grabbed the channel and A had to defer for the retry. For this measurement, A needs a second card, or a near by receiver with good reception.

In this embodiment, false negatives are possible because J is not jamming one hundred percent of the time but may defer to other nodes, and A may decide A ω̅ CS(J) just because J deferred to a faraway node. False positives are also possible because when J is far enough, A can still contend with other nodes if it finds itself in their CS ranges, and may erroneously decide A [symbol] CS(J). As shown in FIG. 2, nodes like C, which are in communication range of the jammer, are not a problem because they will not participate in CS measurement. Nodes like D would not produce false positives because they cannot possibly make A defer. On the other hand, node B tries to evaluate its position relative to CS(J). Node B cannot communicate with J and can make A defer. The worst case is when J is far enough away so that all nodes in CS(A) can produce measurement collisions.

### Randomized Receiver Interference Measurements

Algorithm 4, shown in Table 4, provides a solution for receiver interference.

TABLE 4
Algorithm 4
Randomizing Receiving Interference Measurement

1) Node J broadcasts at full capacity
2) Every node A (excluding J) in the network broadcasts bursts at a rate f,
randomly separated in time
a) every node B (excluding J and A) records d^{B}_{A,J}
3) All nodes in the network take turns at running step 1, while everybody
else runs 2a.

The process shown in Algorithm 4 aims at performing steps of one node broadcasting packets at maximum capacity while, for pairs of nodes, every other node records the delivery ratios with the one node acting as jammer, that is, the process aims at running concurrently all steps 3a in Algorithm 1 above. Toward this end, a permanent jammer (node J) sends at full capacity while pairs of nodes of sources and destinations, e.g. nodes A and B, all concurrently evaluate their respective delivery ratios.

The reduced complexity, from O(n²) in Algorithm 1 to O(n), is achieved by having all sources send at the same time. Interference between sources is negligible when packets are small, low rate, and randomized. The jammer, on the other hand, sends continuously at full throttle, and his influence can be measured by all the affected source-receiver pairs.

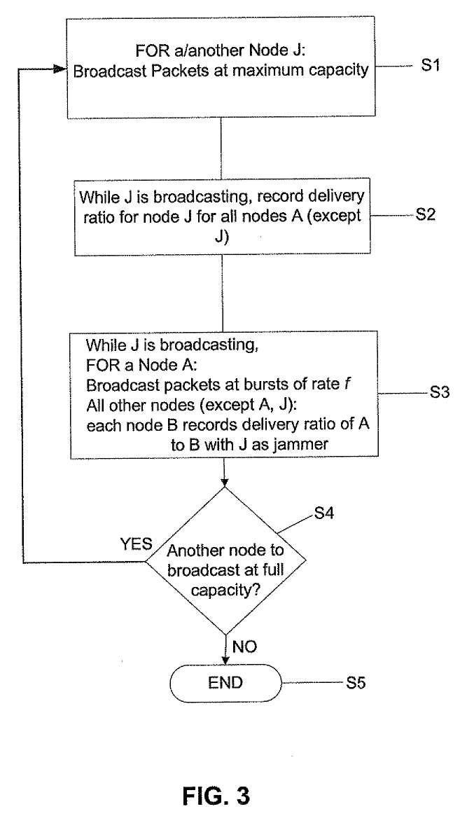

FIG. 3 is a flow diagram for an exemplary embodiment of the inventive process in accordance with Algorithms 1 and 4. In step S1, a node J acts as jammer and broadcasts packets at maximum capacity. While node J is broadcasting, in step S2, a delivery ratio for node J to each other node is calculated. While node J continues to broadcast, a node A (A distinct from J) broadcasts packets at bursts of rate f, randomly separated in time in step S3, and as both nodes J and A are broadcasting, each remaining node B (B distinct from A, and from J) records the delivery ratio of A to B with jammer J. In step S4, a test is performed to determine whether a node remains to act as jammer and broadcast at full capacity. If so (S4=YES), the process returns to step S1 and a node that has not yet broadcast at full capacity becomes node J. Otherwise (S4=NO), all nodes have broadcast at full capacity, and the process is terminated at step S5.

For these measurements to be successful, it is essential that the burst sender nodes in the network do not overlap each other in a systematic fashion. The potential conflicts for a burst sender are only in its interference range and not in the entire network. The collision rate of these measurements is, of course, dependent on the rate f and on the density of the nodes in the interference area.

These algorithms run in linear time, each node in the network taking the role of a full capacity jammer while the other network nodes concurrently estimate delivery ratios and CS relationships.

### Experimental Results

The accuracy of these randomized measurements is compared to measurements at full throughput. Using the madwifi-old driver, packet size of 212 byes, 6 Mbps, and 802.11a, our experiments achieved 2300 packets per second in broadcast mode. This corresponds to about 434 μs per packet, including all overheads. Note that the timings associated with 802.11 include Short InterFrame Space (SIFS) and Distributed Control Function InterFrame Space (DIFS). Considering that SIFS=16 μs, DIFS=34 μs and slot time=9 μs, the value of 434 μs per packet is rather low, indicating a possible non-conformance with the standard by limiting the contention window to a small value.

To evaluate the CS measurement procedure presented in Algorithm 3, packet pairs are sent to a nonexistent MAC destination so that the sending base station retries immediately after the ACK timeout. With a second card, the time difference between the receipt of the two packets is measured. The second trial should increase the window to sixty-four, so the maximum contention window becomes 576 μs, and the total for the second packet 1014 μs. In our measurements without any jammer, the second packet is sent in 430 μs-750 μs, so this is used as a base line for the rest of the comparisons. The distribution of these times is limited to this interval, with very few outliers, so detection of the no CS case is quite robust.

When a jammer is present, the second try is in many cases delayed for the jammer to send one or several packets. Because the jammer is not perfect (it also defers transmission), the sender manages to win a few contentions and have second tries sent in less than 750 μs. By looking at the distribution of these times, the mean and/or median are found to be robust indications for a deferral situation, as they are mostly over 3 ms.

In a twenty-one (21) hour long experiment including a quiet night and a busy weekday, the accuracy and precision of the randomized CS measurement was compared against the basic measurement that uses broadcast at full capacity. Nodes i and j run a ten second simultaneous broadcast and each estimates its own output to the air capacity, essentially csᵢⱼ and csⱼᵢ. Immediately afterwards, i as a sender and j as a jammer execute Algorithm 3 for less than one second, with a period of 100 ms. i is generally able to send nine packets and their associated retries into the air, and a second card in i measures the time difference between the reception of these packets, using the median to estimate the time difference. i and j then exchange roles and for the next second i is the jammer and j the sender. Each node in the pair varies its power setting between 4 dB and 18 dB (card maximum) repeating the above procedure seventeen (17) times in the course of the 21 hour experiment, so that each power configuration is tested 17 times.

Comparison between the two methods is performed using some chosen thresholds for each. For the full broadcast measurement, if csᵢⱼ<0.75, i.e., node i gets less than seventy-five percent access to the medium when j is active, then i defers to j. For the randomized measurement, if the time difference between retries of i when j is jamming is more that 1500 μs, then i defers to j. The sum of false positives and false negatives obtained for a total of 3825 measurements across all different power settings was 2.5%. Considering that these measurements are not simultaneous with the full throughput measurements against which they are compared, some fraction of the differences may be explained by changing conditions in the environment. Another fraction or portion is for the cases when the CS relationship is not binary and cannot be simply reduced to a threshold, so that the source defers to the jammer only for a fraction of the time.

If the operating system can be eliminated as a potential source for inter packet delay, the procedure can work with regular broadcast packets as well. Instead of requiring exactly two tries to a nonexistent destination, bursts of two broadcast packets can be employed for the same purpose. This implementation was tested, and it also provided robust differentiation between CS and non CS situations, but it has not been as extensively tested as the packet pair method.

While the present invention has been described in particular embodiments, it should be appreciated that the present invention should not be construed as limited by such embodiments, but rather construed according to the below claims.

What is claimed is:

1. A method for estimating an interference map for a plurality of nodes in a network, said method comprising the steps of:
continuously broadcasting packets from a jammer node of said plurality of nodes at maximum capacity;
simultaneously recording a delivery ratio from said jammer node to each node of said plurality of nodes, said each node distinct from said jammer node;
randomly broadcasting data from a first node of said plurality of nodes, said first node distinct from said jammer node;
recording a sender interference of said first node to a second node of said plurality of nodes having the sender interference from said jammer node, said second node distinct from said first node and said jammer node;
recording a receiver interference of said second node to said first node having the receiver interference from said jammer node, wherein said steps of recording said sender interference and recording said receiver interference are performed concurrently for all nodes; and
performing each of said previous steps for each node of said plurality of nodes to estimate the interference map comprising the delivery ratio, the sender interference, and the receiver interference for each node.

2. The method according to claim 1, wherein said jammer node comprises a jammer node sender interference, said randomly broadcasting data is broadcast at a rate, and said continuously broadcasting packets is performed with the jammer node sender interference disabled.

3. The method according to claim 1, wherein the network is one of 802.11a and 802.11e.

4. A method for estimating an interference map for a plurality of nodes in a network, said method comprising the steps of:
continuously broadcasting packets from a jammer node of said plurality of nodes at maximum capacity;
simultaneously recording a delivery ratio from said jammer node to each node of said plurality of nodes, said each node distinct from said jammer node;
unicasting data at least a first time and a second time to a nonexistent address from a first node of said plurality of nodes, said first node distinct from said jammer node, and measuring a time difference between a receipt of the broadcast data broadcast the first time and the second time at the first node;
recording a sender interference of said first node to a second node of said plurality of nodes having the sender interference from said jammer node, said second node distinct from said first node and said jammer node;
recording a receiver interference of said second node to said first node having the receiver interference from said jammer node, wherein said steps of recording said sender interference and recording said receiver interference are performed concurrently for all nodes; and
performing each of said previous steps for each node of said plurality of nodes to estimate the interference map comprising the delivery ratio, the sender interference, and the receiver interference for each node.

5. The method according to claim 4, wherein the network is one of 802.11a and 802.11e.

6. A computer readable medium having computer readable program for operating on a computer for estimating an interference map for a plurality of nodes in a network, said program comprising instructions that cause the computer to perform the steps of:
continuously broadcasting packets from a jammer node of said plurality of nodes at maximum capacity;
simultaneously recording a delivery ratio from said jammer node to each node of said plurality of nodes, said each node distinct from said jammer node;
randomly broadcasting data from a first node of said plurality of nodes, said first node distinct from said jammer node;
recording a sender interference of said first node to a second node of said plurality of nodes having the sender interference from said jammer node, said second node distinct from said first node and said jammer node;
recording a receiver interference of said second node to said first node having the receiver interference from said jammer node, wherein said steps of recording said sender interference and recording said receiver interference are performed concurrently for all nodes; and
performing each of said previous steps for each node of said plurality of nodes to estimate the interference map comprising the delivery ratio, the sender interference, and the receiver interference for each node.

7. The computer program according to claim 6, wherein said jammer node comprises a jammer node sender interference, said randomly broadcasting data is broadcast at a rate, and said continuously broadcasting packets is performed with the jammer node sender interference disabled.

8. The computer program according to claim 6, wherein the network is one of 802.11a and 802.11e.

9. A computer readable medium having computer readable program for operating on a computer for estimating an interference map for a plurality of nodes in a network, said program comprising instructions that cause the computer to perform the steps of:
continuously broadcasting packets from a jammer node of said plurality of nodes at maximum capacity;
simultaneously recording a delivery ratio from said jammer node to each node of said plurality of nodes, said each node distinct from said jammer node;
unicasting data at least a first time and a second time to a nonexistent address from a first node of said plurality of nodes, said first node distinct from said jammer node, and measuring a time difference between a receipt of the broadcast data broadcast the first time and the second time at the first node;
recording a sender interference of said first node to a second node of said plurality of nodes having the sender interference from said jammer node, said second node distinct from said first node and said jammer node;
recording a receiver interference of said second node to said first node having the receiver interference from said jammer node, wherein said steps of recording said sender interference and recording said receiver interference are performed concurrently for all nodes; and
performing each of said previous steps for each node of said plurality of nodes to estimate the interference map comprising the delivery ratio, the sender interference, and the receiver interference for each node.

10. The computer program according to claim 9, wherein the network is one of 802.11a and 802.11e.
